(19) United States
(12) Patent Application Publication
(10) Pub. No.: US 2008/0172293 A1
(43) Pub. Date: Jul. 17, 2008

(54) Optimization framework for association of advertisements with sequential media

(75) Inventors: Oliver M. Raskin, Portland, OR (US); Marc E. Davis, San Francisco, CA (US); Eric M. Fixler, Oakland, CA (US); Ronald G. Martinez, San Francisco, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc.

(21) Appl. No.: 11/646,970

(22) Filed: Dec. 28, 2006

(51) Int. Cl. G07G 1/14; G07F 7/00

(52) U.S. Cl. 705/14; 705/27

(57) ABSTRACT

A method and apparatus are disclosed that are suitable for automatically identifying appropriate advertisements and locations for composting an advertisement with a media file for user consumption.

### FIELD OF THE INVENTION

The embodiments relate generally to placing media and advertisements. More particularly, the embodiments relate to an optimization framework for association of advertisements with sequential media.

### BACKGROUND

The explosion of Internet activity over the past years has created enormous growth for advertising on the Internet. However, the current Internet advertising market is fragmented with sellers of advertisements not being able to find suitable media to composite with an advertisement. Additionally, current methods of purchasing and scheduling advertising against sequential/temporal media (most typically, audio or video content, downloadable media, movies, audio programs, television programs, etc.) are done without a granular understanding of the elements of content that the media may contain. This is because such media has been inherently opaque and difficult to understand at a detailed level. Generally, the advertisement schedulers only have a high-level summary available during the time that decisions are made with respect to what advertisements to run.

However, there exists within programs (e.g., downloadable media, movies, audio programs, television programs, etc.) a wide spectrum of context, including by not limited to, a diversity of characters, situations, emotions, and visual or audio elements. Accordingly, specific combinations of plot, action, setting, and other formal elements within both the program and advertising media lend themselves as desirable contextual adjacency opportunities for some brands and marketing tactics, but not for others.

However, because current advertisement methods focus on the high-level program summary they are not able to exploit the wide spectrum of advertisement spaces available within a given advertisement. Additionally, the time for one to manually review content for placement of an appropriate advertisement would be prohibitive. Accordingly, what is needed is an automated method for identifying opportunities for compositing appropriate advertisements with sequential media.

### BRIEF SUMMARY

A first embodiment includes a method for providing a best offer with a sequential content file. The method includes receiving an offer request to provide a best offer with a sequential content file wherein the sequential content file has associated metadata. The method also includes retrieving a plurality of offers from an offer store and determining at least one opportunity event in the sequential content file. The method also includes optimizing the plurality of offers to determine the best offer, customizing the best offer with the sequential content file, and providing the best offer with the sequential content file.

Another embodiment is provided in a computer readable storage medium having stored therein data representing instructions executable by a programmed processor to provide a best offer with a sequential content file. The storage medium includes instructions for receiving an offer request to provide a best offer with a sequential content file. The embodiment also includes instructions for retrieving a plurality of offers from an offer store and determining at least one opportunity event in the sequential content file. The embodiment also includes instructions for optimizing the plurality of offers to determine the best offer and providing the best offer with the sequential content file.

Another embodiment is provided that includes a computer system that includes a semantic expert engine to analyze metadata of a sequential content file, an offer optimization engine to select a best offer from a plurality of offers, and an offer customization engine to customize the best offer and the sequential content file.

Another embodiment is provided that includes a computer system that includes one or more computer programs configured to determine a best offer for association with a sequential content file from a plurality of offers by analyzing one or more pieces of metadata associated with the sequential content file.

The foregoing discussion of the embodiments has been provided only by way of introduction. Nothing in this section should be taken as a limitation on the following claims, which define the scope of the invention.

### BRIEF DESCRIPTION OF THE SEVERAL VIEWS OF THE DRAWINGS

The embodiments will be further described in connection with the attached drawing figures. It is intended that the drawings included as a part of this specification be illustrative of the embodiments and should in no way be considered as a limitation on the scope of the invention.

FIG. 1 is a block diagram of an embodiment of a system for determining a best offer for insertion into a content file or stream for delivery to an end user;

FIG. 2 is a block diagram of an embodiment of a process by which metadata associated with media files is extracted and made available to the system;

FIG. 3 is a block diagram of an embodiment of a process for selecting and delivering appropriate offers to a user;

FIG. 4 is a block diagram of an embodiment of a semantic expert engine for performing a variety of cleaning, normalization, disambiguation, and decision processes;

FIG. 5 is a block diagram of an embodiment of a concept expert process;

FIG. 6 is an embodiment of an opportunity event expert for identifying media opportunity events within a content file or stream;

FIG. 7 is an exemplary portion of a content file depicting exemplary opportunities for compositing an advertisement with the content file;

FIG. 8 is a block diagram of an embodiment of an optimization function for selecting a best offer to associate with an opportunity event; and

FIG. 9 is a block diagram of an exemplary interstitial advertisement for an exemplary vehicle advertisement.

### DETAILED DESCRIPTION OF PRESENTLY PREFERRED EMBODIMENTS

The exemplary embodiments disclosed herein provide a method and apparatus that are suitable for identifying and composting appropriate advertisements with a sequential/temporal media content file or stream. In particular, it automates and optimizes a traditionally manual process of identifying appropriate advertisements and compositing them with sequential/temporal media wherein the amount and diversity of programming approaches infinity and the mechanisms for reaching customers and communicating brand messages become more customized and complex. This process applies to traditional editorial methods, where playback of the content file or stream program is interrupted in order to display another media element, and it also applies to other superimposition methods, where graphical, video, audio, and textual content is merged with, superimposed on, or otherwise integrated into, existing media content.

Furthermore, advertisers desire increased control over the ability to deliver their marketing messages in contexts favorable to creating positive associations with their brand (also known as “contextual adjacency”). This service enables significantly greater control over the contextual adjacency of marketing tactics associated with audio and video content, and due to its degree of automated and distributed community processing, makes it possible to leverage niche “tail” content as a delivery vehicle for highly targeted marketing.

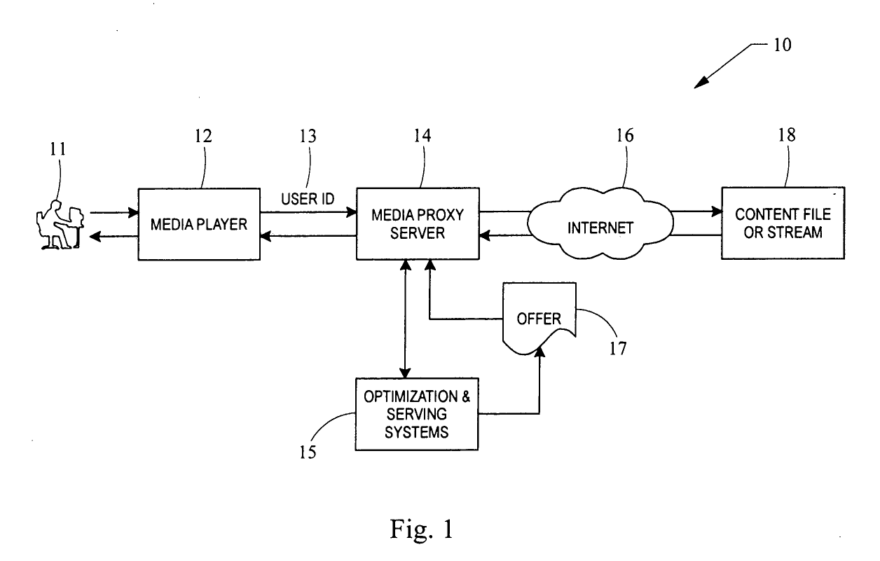

A more detailed description of the embodiments will now be given with reference to FIGS. 1-9. Throughout the disclosure, like reference numerals and letters refer to like elements. The present invention is not limited to the embodiments illustrated; to the contrary, the present invention specifically contemplates other embodiments not illustrated but intended to be included in the claims.

FIG. 1 depicts a flowchart of an embodiment of the system 10. In the illustrated embodiment, the system 10 includes one or more users such as user 11, media player 12, media proxy server 14; optimization and serving systems 15, and content file or media stream 18 which may be remotely located and accessible over a network such as the Internet 16.

The system 10 allows access of media content from the remote location by the user 11. In particular, in one embodiment, user 11 requests a media content file or stream 18 through Internet 16 be played through media player 12. Media player 12 may be software installed onto a personal computer or a dedicated hardware device. The player 12 may cache the rendered content for consumption offline or may play the media file immediately. For example, a user may click a URL in a web browser running on a personal computer that may launch an application forming media player 12 on the personal computer. Media player 12 could be configured to request content files or streams 18 through media proxy server 14 that will in turn request content files or streams 18 from the location indicated by the URL, parse this content to extract metadata, and issue a request to the optimization and serving systems 15.

Before user 11 consumes content file or stream 18, any selected advertisements or offers 17 are composited with media file by being placed directly into the media file or by direct or indirect delivery of the actual offer or a reference to the offer to the media player for later assembly and consumption. Offers 17 include but are not limited to, advertising messages from a brand to a consumer which is embodied in a piece of advertising creative built from the building blocks of format, layout, and tactic to form a given advertisement. Formats include, but are not limited to, audio, video, image, animation, and text. Layouts include, but are not limited to, interstitial, composite, and spatial adjunct. Tactic includes, but is not limited to, product placement, endorsement, and advertisement. Similarly, an offer may also be defined as a software function that builds and customizes a piece of advertising creative from a mix of static and dynamic elements. For example, an advertisement for a car may be assembled from a selection of static and dynamic elements that include, but are not limited to, a vehicle category, a selection from a background scene category, and a selection from a music category.

Optimization and servings systems 15 determine which offer 17 to use and where it should be composited with content file or stream 18. Content file or stream 18 together with final offer 17 are then delivered to user II through media proxy server 14 and media player 12.

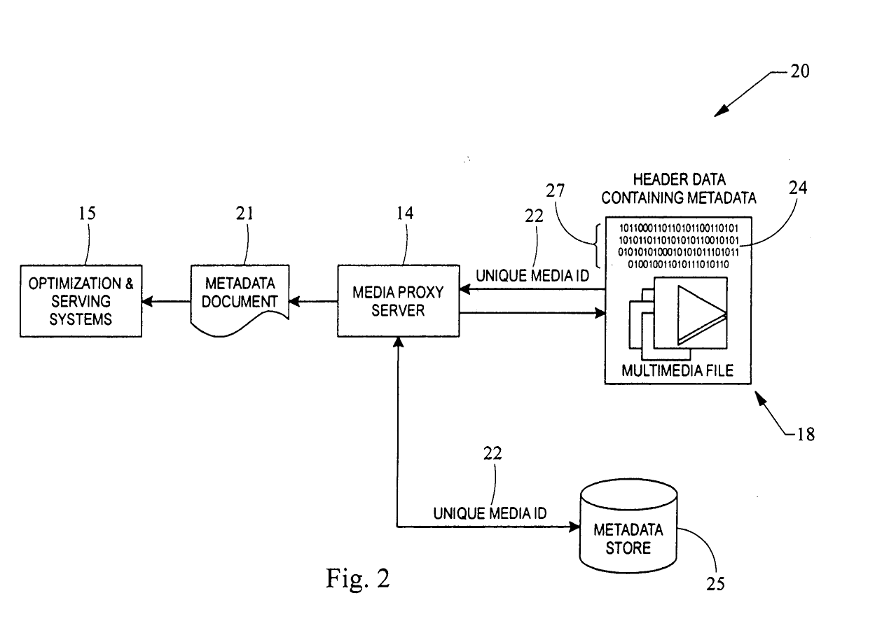

FIG. 2 depicts an embodiment 20 of the process by which metadata 24, that is associated with content file or stream 18, is extracted from file 18 and made available to optimization and serving systems 15. This embodiment includes optimization and serving systems 15 that determine which offer to use, as depicted in FIG. 1. Optimization serving systems 15 may be implemented as a single piece or multiple pieces of software code running on the same or different processors and stored in computer readable memory. System 20 further includes media proxy server 14 for obtaining data from metadata store 25 using unique media id 22 from content file or stream 18.

In particular, content file or stream 18 has previously been annotated and encoded with metadata 24 that is stored in a machine-readable format. Unlike text documents, which are readily machine readable, media files (audio, video, image) are inherently opaque to downstream processes and must be annotated through automatic or human-driven processes.

A wide variety of machine readable annotations (metadata) may be present to describe a media file. Some will describe the file's structure and form, while others will describe the file's content. These annotations may be created by automated processes, including but not limited to, feature extraction, prosodic analysis, speech to text recognition, signal processing, and other analysis of audiovisual formal elements. Annotations may also be manually created by those, including but not limited to, content creators, professional annotators, governing bodies, or end users. The two broad types of annotations, i.e. human- and machine-derived, may also interact, with the derivation pattern relationships between the two enhancing the concept and segment derivation processes over time. Metadata may be in the form of “structured metadata” in which the instances or classes of the metadata terms are organized in a schema or ontology, i.e., a structure which is designed to enable explicit or implicit inferences to be made amongst metadata terms. Additionally, a large amount of available metadata can be in the form of “unstructured metadata” or “tags” which are uncontrolled folksonomic vocabularies. A folksonomy is generally understood to be an Internet-based information retrieval methodology consisting of collaboratively generated, open-ended labels that categorize content such as Web pages, online photographs, and Web links. While “tags” are traditionally collected as unstructured metadata, they can be analyzed to determine similarity among terms to support inferential relationships among terms such as subsumption and co-occurrence. Additional details regarding folksonomy is generally available on the World Wide Web at: answers.com/topic/folksonomy and is hereby incorporated by reference.

The following is an exemplary non-exhaustive review of some types of annotations which may be applied to media content. A more complete treatment of the annotations particular to media, and the knowledge representation schemas specific to video may be found on the World Wide Web at: chiariglione.org/MPEG/standards/mpeg-7/mpeg-7.htm#2.5_MPEG-7_Multimedia_Description_Schemes and on the Internet at fusion.sims.berkeley.edu/GarageCinema/pubs/pdf/pdf_{—}0EBD60E0-96D2-487B-95DFCEC6B0B542D9.pdf respectively, both of which are hereby incorporated by reference.

Media files can contain metadata that is information that describes the content of the file itself. As used herein, the term “metadata” in not intended to be limiting; there is no restriction as to the format, structure, or data included within metadata. Descriptions include but are not limited to, representations of place, time, and setting. For example, the metadata may describe the location as a “beach,” and time as “daytime.” Or, for example, the metadata might describe the scene occurring in year “1974” located in a “dark alley.” Other metadata can represent an action. For example, metadata may describe “running,” “yelling,” “playing,” “sitting,” “talking,” “sleeping,” or other actions. Similarly, metadata may describe the subject of the scene. For example, the metadata may state that the scene is a “car chase,” “fist fight,” “love scene,” “plane crash,” etc. Metadata may also describe the agent of the scene. For example, the metadata might state “man,” “woman,” “children,” “John,” “Tom Cruise,” “fireman,” “police officer,” “warrior,” etc. Metadata may also describe what objects are included in the scene, including but not limited to, “piano,” “car,” “plane,” “boat,” “pop can,” etc.

Emotions can also be represented by metadata. Such emotions could include, but are not limited to, “angry,” “happy,” “fearful,” “scary,” “frantic,” “confusing,” “content,” etc. Production techniques can also be represented by metadata, including but not limited to: camera position, camera movement, tempo of edits/camera cuts, etc. Metadata may also describe structure, including but not limited to, segment markers, chapter markers, scene boundaries, file start/end, regions (including but not limited to, sub areas of frames comprising moving video or layers of a multichannel audio file), etc.

Metadata may be provided by the content creator. Additionally, end users may provide an additional source of metadata called “tagging.” Tagging includes information such as end user entered keywords that describe the scene, including but not limited to those categories described above. “Timetagging” is another way to add metadata that includes a tag, as described above, but also includes information defining a time at which the metadata object occurs. For example, in a particular video file, an end user might note that the scene is “happy” at time “1 hr., 2 min.” but “scary” at another time. Timetags could apply to points in temporal media (as in the case of “happy” at “1 hr., 2 min.” or to segments of temporal media such as “happy” from ““1 hr., 2 min.” to “1 hr., 3 min.”.

Software algorithms can be used to quantitatively analyze tags and determine what tags are the key tags. Thus, while typically a single end user's tag may not be considered an important piece of metadata, when combined with multiple end users' tags that include similar tags, the more weighty the tag becomes. In other words, the more end users who annotate the file in the same way, the more important those tags become to the systems that analyze how an advertisement ought to be composited with the file. Thus, an implicit measurement of interest and relevance may be collected in situations where a large number of consumers are simultaneously consuming and sharing content. Metrics such as pauses, skips, rewinds/replays, and pass-alongs/shares of segments of content are powerful indicators that certain moments in a piece of media are especially interesting, amusing, moving, or otherwise relevant to consumers and worthy of closer attention or treatment.

Along with annotations that are intended to describe the content, there are also specific annotations that are intended to be parsed by the software or hardware player and used to trigger dependent processes, such as computing new values based on other internal or external data, querying a database, or rendering new composite media. Examples might be an instruction to launch a web browser and retrieve a specific URL, request and insert an advertisement, or render a new segment of video which is based on a composite of the existing video in a previous segment plus an overlay of content which has been retrieved external to the file. For example, a file containing stock footage of a choir singing happy birthday may contain a procedural instruction at a particular point in the file to request the viewer's name to be retrieved from a user database and composited and rendered into a segment of video that displays the user's name overlaid on a defined region of the image (for example, a blank canvas).

Additionally, logical procedure instructions can also be annotated into a media file. Instead of a fixed reference in the spatial-temporal structure of the sequence (e.g., “frames 100 to 342”), the annotation makes reference to sets of conditions which must be satisfied in order for the annotation to be evaluated as TRUE and hence, activated. An exemplary instruction might include:

```
INSERT ADVERTISEMENT IF
  {
    AFTER Segment (A)
        AND <5 seconds BEFORE Scene End
        AND PLACE = OCEAN
    }
```

Such annotations may survive transcodings, edits, or rescaling of source material which would otherwise render time or space-anchored types of annotations worthless. They may also be modified in situ as a result of computational analysis of the success or failure of past placements.

Additionally, terms of use, rights, and financial metadata may be annotated into a file. These notations describe information about the usage process of the media content, including links to external rights holder management authorities who enforce the rights associated with a media object. The terms may also include declarations of any rules or prohibitions on the types and amount of advertising that may be associated with a piece of content, and/or restrictions on the categories or specific sponsors that may be associated with the content (e.g., “sin” categories such as tobacco or alcohol). Financial data may contain information related to the costs generated and income produced by media content. This enables an accounting of revenue generated by a particular media file to be made and payments distributed according to aforementioned rights declarations.

Metadata 24 may be stored as a part of the information in header 27 of file 18, or encoded and interwoven into the file content itself, such as a digital watermark. One standard which supports the creation and storage of multimedia description schemes is the MPEG 7 standard. The MPEG 7 standard was developed by the Moving Picture Experts Group and is further described in “MPEG-7 Overview,” ISO/IECJTC1/SC29/WG11N6828, ed. José M. Martínez (October 2004), which is hereby incorporated by reference.

If, however, metadata 24 is stored external to file 18, media proxy server 14 retrieves metadata 24 from centrally accessible media store 25 using a unique media object id 22 that is stored with each media file 18. Media proxy server 14 reads in and parses metadata 24 and renders metadata document 21. Metadata document 21 is then passed downstream to optimization and serving systems 15.

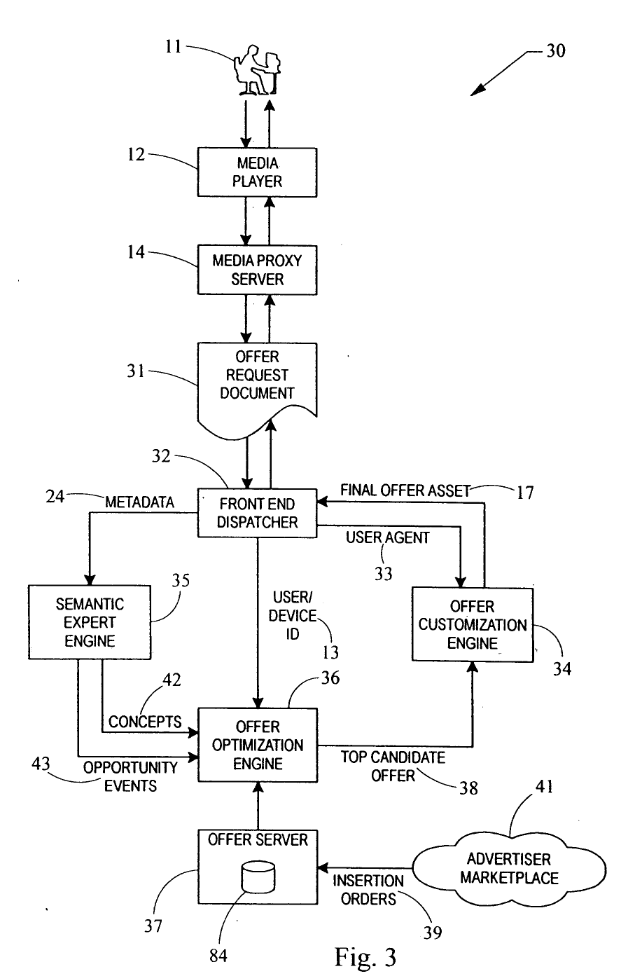

FIG. 3 depicts an embodiment 30 of the process of selecting and later delivering an appropriate offer to user 11 (FIG. 1). In the embodiment 30 of FIG. 3, the process is implemented in a system including media player 12, media proxy server 14, front end dispatcher 32, offer customization engine 34, semantic expert engine 35, offer optimization engine 36, and offer server 37. Front end dispatcher 32, offer customization engine 34, semantic expert engine 35, offer optimization engine 36, and offer server may be implemented as a single piece or multiple pieces of software code running on the same or different processors and stored in computer readable memory.

Here, media proxy server 14 initiates optimization and serving process by passing an offer request 31 to front end dispatcher 32. Offer request 31 is presented in a structured data format which contains the extracted metadata 24 for the target content file 18, a unique identifier of the user or device, as well as information about the capabilities of the device or software which will render the media. Front end dispatcher 32 is the entry point to the optimization framework for determining the most suitable offer 17 for the advertisement space. Front end dispatcher 32 manages incoming requests for new advertisement insertions and passes responses to these requests back to media proxy server 14 for inclusion in the media delivered to end user 11.

Front end dispatcher 32 interacts with multiple systems. Front end dispatcher 32 interacts with media proxy server 14 that reads content files, passes metadata to front end dispatcher 32, and delivers content and associated offers 17 to user 11 for consumption. It also interacts with semantic expert engine 35 that analyzes metadata annotations to identify higher level concepts that act as common vocabulary allowing automated decision-making on offer selection and compositing. Front end dispatcher 32 further interacts with offer optimization engine 36 that selects the best offers for available inventory. Offer customization engine 34, that interacts with front end dispatcher 32, varies elements of offer 38 according to data available about the user and the context in which offer is delivered and passes back final offer asset 17.

Front end dispatcher 32 reads multiple pieces of data from offer request document 31 and then passes the data onto subsystems as follows. First, unique ID 13 of user 11 requesting the file is passed to offer optimization engine 36. User-agent 33 of the device/software requesting the file is passed to the offer customization engine 34. Any additional profile information available about user 11, including but not limited to, the user's history of responses to past offers and information which suggests the user's predilections toward specific media and offers is passed to offer optimization engine 36. Metadata 24 associated with the file being requested (or a link to where that metadata is located and can be retrieved), including metadata about the content itself as well as formal qualities of the content, is passed to the semantic expert engine 35. Front end dispatcher 32 passes the parsed metadata 24 and user ID 13 to the semantic expert engine 35.

Processes of semantic expert engine 35 are employed to analyze the descriptive and instructive metadata 24 which has been manually or programmatically generated as described above. Processes for semantic expert engine 35 assign meaning to abstract metadata labels to turn them into higher level concepts that use a common vocabulary for describing the contents of the media and allow automated decision-making on advertisement compositing. Each of the processes may be implemented as a single piece or multiple pieces of software code running on the same or different processors and stored in computer readable memory.

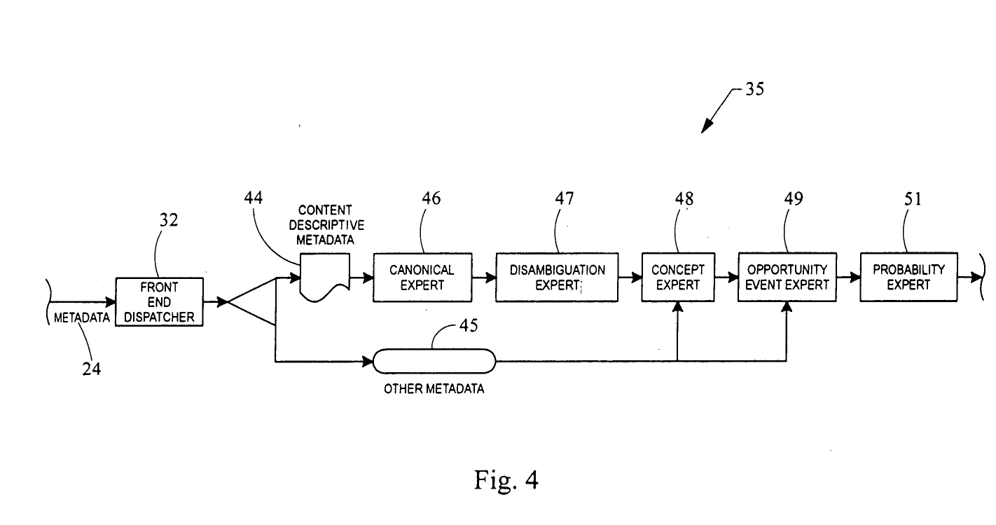

To make use of metadata 24 tags, semantic expert engine 35 performs a variety of cleaning, normalization, disambiguation and decision processes, an exemplary embodiment 35 of which is depicted in FIG. 4. The embodiment 35 includes front end dispatcher 32, canonical expert 46, disambiguation expert 47, concept expert 48, opportunity event expert 49, and probability expert 51. Each expert may be implemented as a single piece or multiple pieces of software code running on the same or different processors and stored in computer readable memory.

Front end dispatcher 32 of semantic expert engine 35 parses the incoming metadata document 24 containing metadata to separate content descriptive metadata (“CDM”) 44 from other types of data 45 that may describe other aspects of the content file or stream 18 (media features, including but not limited to, luminosity, db levels, file structure, rights, permissions, etc.). CDM 44 is passed to canonical expert 46 where terms are checked against a spelling dictionary and canonicalized to reduce variations, alternative endings, parts of speech, common root terms, etc. These root terms are then passed to the disambiguation expert 47 that analyzes texts and recognizes references to entities (including but not limited to, persons, organizations, locations, and dates).

Disambiguation expert 47 attempts to match the reference with a known entity that has a unique ID and description. Finally, the reference in the document gets annotated with the uniform resource identifier (“URI”) of the entity.

Semantically annotated CDM 44 is passed to the concept expert 48 that assigns and scores higher-order concepts to sets of descriptors according to a predefined taxonomy of categories which has been defined by the operators of the service. For example, concepts may be associated with specific ranges of time in a media file or may be associated with a named and defined segment of the media file. This taxonomy provides the basis for a common framework for advertisers to understand the content of the media which may deliver the advertiser's message. Concept ranges may overlap and any particular media point may exist simultaneously in several concept-ranges. Overlapping concept ranges of increasing length can be used to create a hierarchical taxonomy of a given piece of content

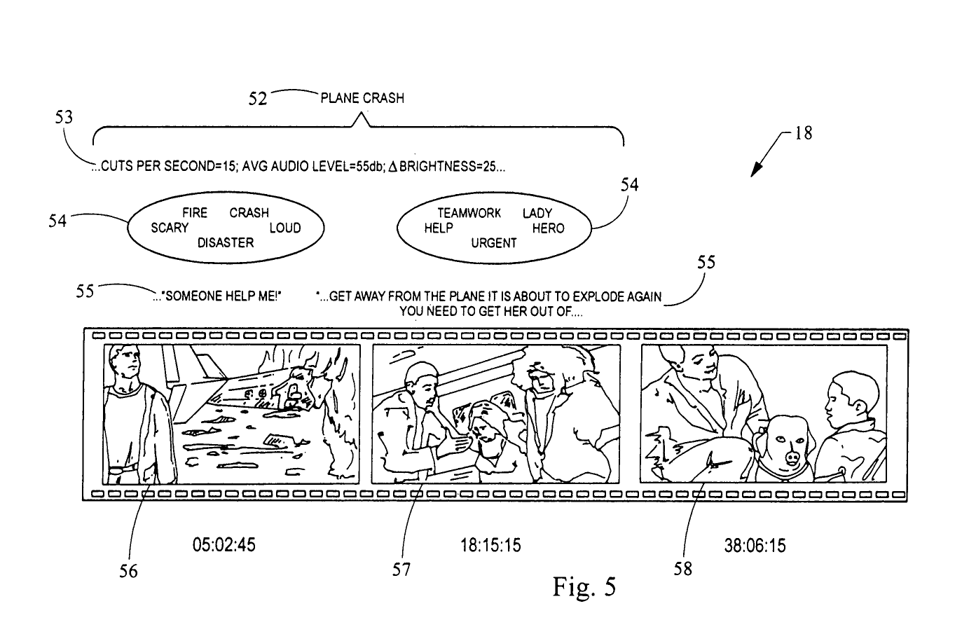

An exemplary concept expert analysis is further depicted in FIG. 5 that depicts information associated with an exemplary content file or stream 18 accessed by user 11 (FIG. 1). Here, content file or stream 18 depicts a plane crash made up of three scenes, 56, 57, and 58. In this example, two adjacent scenes 56, 57 have been annotated 54. Extractions of closed caption dialogue 55 and low level video and audio features 53 have also been made available. Examples of these features include, but are not limited to, formal and sensory elements such as color tone, camera angle, audio timbre, motion speed and direction, and the presence of identifiable animate and inanimate elements (such as fire). These features may be scored and correlated to other metadata, including but not limited to, tags and keywords. Additionally, tags and keywords can be correlated against feature extraction to refine the concept derivation process. Concept expert 48 determines that scenes 56, 57 belong to the concept 52 “Plane Crash.” That information is then passed to opportunity event expert 49 depicted in FIG. 4.

Opportunity event expert 49 implements a series of classification algorithms to identify, describe, and score opportunity events in the content file or stream 18. An opportunity event includes but is not limited to, a spatiotemporal point or region in a media file which may be offered to advertisers as a means of compositing an offer (advertising message) with the media. Thus, opportunity events include the offer format, layout, and tactic that it can support. The algorithms recognize patterns of metadata that indicate the presence of a specific type of marketing opportunity. Additionally an opportunity event may be a segment of media content that the author explicitly creates as being an opportunity event. The author may add metadata and/or constraints to that opportunity event for matching with the right ad to insert into an intentionally and explicitly designed opportunity event. Thus, opportunity events not only include events determined by the system to be the best to composite with an ad, but also include author-created opportunity events explicitly tagged for composting with an ad.

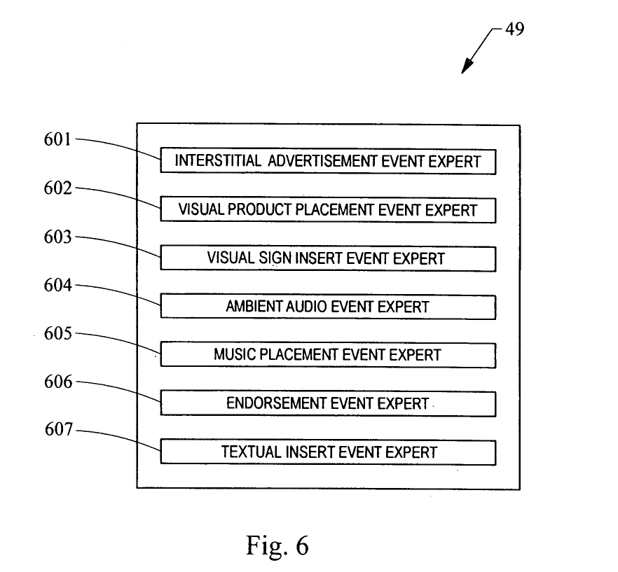

FIG. 6 depicts exemplary algorithms for use with opportunity event expert 49, including interstitial advertisement event expert 601, visual product placement event expert 602, visual sign insert event expert 603, ambient audio event expert 604, music placement event expert 605, endorsement event expert 606, and textual insert event expert 607. Each expert may be implemented as a single piece or multiple pieces of software code running on the same or different processors and stored in computer readable memory. There are a number of known algorithms suitable for analyzing source and destination images to. determine where a source image ought to be placed. Examples of suitable algorithms that may be used in combination with another include, but are not limited to, feature extraction algorithms, pattern recognition algorithms, hidden Markov models (related to Bayesian algorithms for positive feedback), geometric feature extraction algorithms (e.g. acquiring 3-dimensional data from 2-dimensional images); Levenberg-Marquardt non-linear least squares algorithm; corner detection algorithms; edge detection algorithms; wavelet based salient point detection algorithms; affine transformation algorithms; discrete Fourier transforms; digital topology algorithms; composting algorithms; perspective adjustment algorithms; texture mapping algorithms; bump mapping algorithms; light source algorithms; and temperature detection algorithms. Known suitable audio algorithms for determining viable audio interpolation spaces within sequential media include, but are not limited to, amplitude analysis over time, frequency analysis over time, and fast Fourier transforms.

Each opportunity event may be considered a slot within the media for which a single best offer may be chosen and delivered to the consumer. There may be multiple opportunity events within a single media file that are identified by opportunity event expert 49, and many events may be present within a small span of time. Additionally, each event expert is capable of transforming the target content (i.e. the content to be composited with the video) for seamless integration with the video. Thus, as circumstances change within the video, the target content can also be modified so as to be seamlessly integrated with the video. For example, the target content may be translated, rotated, scaled, deformed, remixed, etc. Transforming target (advertising) content for seamless integration with video content is further described in U.S. patent application Ser. No. ______, now U.S. Pat. No. ______, filed Dec. 28, 2006, assigned to the assignee of this application, and entitled System for Creating Media Objects Including Advertisements, which is hereby incorporated by reference in its entirely.

Interstitial advertisement event expert 601 composites a traditional 15 or 30 second (or more or less) audio or video commercial, much like those the break up traditional television programs, with a media file. Since interstitial advertisements are not impacted by the internal constraints of the media content, such advertisements will typically be the most frequently identified opportunity event. To find interstitial opportunities, the interstitial advertisement event expert 601 of opportunity event expert 49 may search for logical breakpoints in content (scene wipes/fades, silence segments, creator-provided annotations (suggested advertisement slots, for example), or periods whose feature profiles suggest that action/energy (e.g., pacing of shots in a scene, db level of audio) in the piece has risen and then abruptly cut off—breaks in a tension/action scene are moments of high audience attention in a program and a good candidate for sponsorship. Thus, interstitial advertisement event expert 601 identifies logical breakpoints wherein the offer could be composited. If a suitable place is found, interstitial advertisement event expert 601 outputs code to describe the frame of video that is suitable for the interstitial advertisement and generates a list of all the frames for which this event is valid.

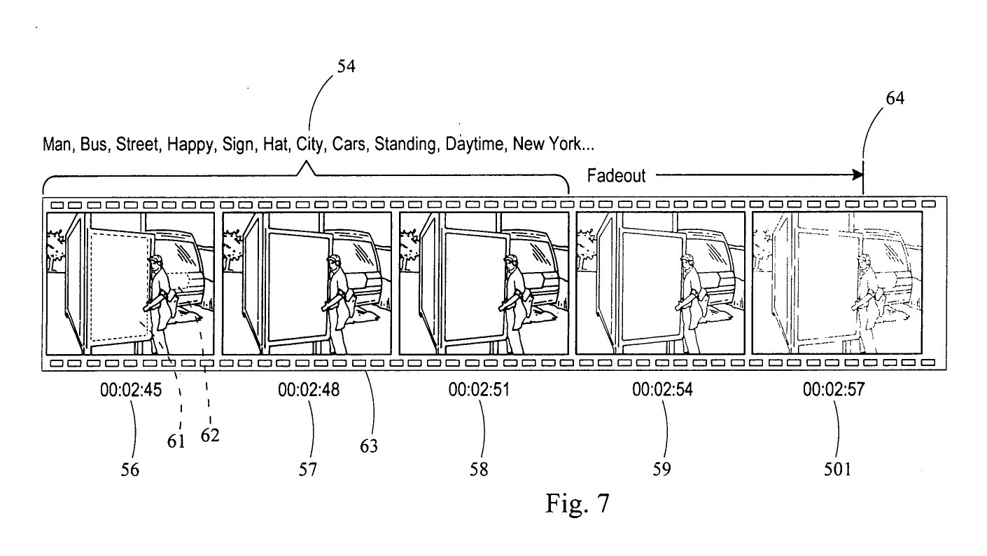

For example, as depicted in FIG. 7, interstitial advertisement event expert 601 may analyze a series of video frames (e.g. 48 frames, 2 seconds, etc.) 56, 57, 58, 59, 501 during which an area can be found which has image properties that suggest it would be suitable for an interstitial advertisement. The fade to black 64 suggests that this is an opportunity for insertion of an interstitial advertisement. The availability of this region for insertion could be influenced by surrounding factors in the media, such as length of the fade, pacing or chrominance/luminance values of the contiguous regions, and/or qualities of the accompanying audio, as well as the explicit designation of this region, via an interactive mechanism, as being available (or unavailable) for offer insertion.

Visual product placement event expert 602 composites a graphical image of a product with a scene of content media file or stream; it identifies objects (2-dimensional and 3-dimensional transformations) that could likely hold the offer. The characters of the scene do not interact with the product. For example, a soda can could be placed on a table in the scene. However, a 3-dimensional soda can would likely look awkward if placed on a 2-dimensional table. Thus, visual product placement event expert 602 identifies the proper placement of the product and properly shades it so that its placement looks believable.

As depicted in FIG. 7, visual product placement event expert 602 may analyze a series of video frames (e.g. 48 frames, 2 seconds, etc.) 56, 57, 58, 59, 501 during which an area can be found which has image properties that suggest it would be suitable for superimposition of a product. If a suitable location is found, visual product placement event expert 602 outputs code to describe the region within each frame of video that is suitable for the overlay and generates a list of all the frames for which this event is valid.

For example, in FIG. 7, visual product placement event expert 602 identified area 62 for the placement of a bicycle of a certain brand to be carried on the front of the bus.

Endorsement event expert 606 composites a product into a media for interaction with a character in the media. Thus, endorsement event expert 606 is like visual product placement event expert 602, but it further looks to alter the scene so that the character of the scene interacts with the product. The endorsement event expert could also create indirect interaction between the inserted product and the characters or objects in the scene through editing techniques that create an indirect association between a character and an object or other character utilizing eyeline matching and cutaway editing. The endorsement event expert analyzes the video to derive appropriate 2½D (2D+layers), 3D, 4D (3D+time), and object metadata to enable insertion of objects in the scene that can be interacted with. If a suitable location is found, endorsement event expert 606 outputs code to describe the region within each frame of video that is suitable for the overlay and generates a list of all the frames for which this event is valid. The endorsement event expert could also function in the audio domain to include inserted speech so it can make a person speak (through morphing) or appear to speak (through editing) an endorsement as well. The endorsement event expert may also transform the inserted ad content to enable the insertion to remain visually or auditorially convincing through interactions with the character or other elements in the scene.

For example, instead of placing a soda can on a table, endorsement event expert 606 can place the soda can in a character's hand. Thus, it will appear as though the character of the scene is endorsing the particular product with which the character interacts. If the character opens the soda can, crushes it, and tosses the soda can in a recycling bin, appropriate content and action metadata about the target scene would facilitate the transformation of the inserted ad unit to match these actions of the character in the scene by translating, rotating, scaling, deforming, and compositing the inserted ad unit.

Visual sign insert event expert 603 forms a composite media wherein a graphical representation of a brand logo or product is composited into a scene of video covering generally featureless space, including but not limited to, a billboard, a blank wall, street, building, shot of the sky, etc. Thus, the use of the term “billboard” is not limited to actual billboards, but is directed towards generally featureless spaces. Textural, geometric, and luminance analysis can be used to determine that there is a region available for graphic, textual, or visual superimposition. It is not necessarily significant that the region in the sample image is blank; a region with existing content, advertising or otherwise, could also be a target for superimposition providing it satisfied the necessary geometric and temporal space requirements. Visual sign insert event expert 603 analyzes and identifies contiguous 2-dimensional space to insert the offer at the proper angle by comparing the source image with the destination image and determining a proper projection of the source image onto the destination image such that the coordinates of the source image align with the coordinates of the destination. Additionally, visual sign insert event expert 603 also recognizes existing billboards or visual signs in the video and is able to superimpose ad content over existing visual space, therefore replacing content that was already included in the video. If a suitable location is found, visual sign insert event expert 603 outputs code to describe the region within each frame of video that is suitable for the overlay and generates a list of all the frames for which this event is valid.

For example, as depicted in FIG. 7, visual sign insert event expert 603 may analyze a series of video frames (e.g. 48 frames, 2 seconds, etc.) 56, 57, 58, 59, 501 during which a rectangular area can be found which has image properties that suggest it is a blank wall or other unfeatured space which would be suitable for superimposition of an advertiser logo or other text or media, such as 61.

Textual insert event expert 607 inserts text into a video. In particular, textual insert event expert 607 can swap out text from a video using Optical Character Recognition and font matching to alter the text depicted in a video or image. Examples of alterable content include, but are not limited to, subtitles, street signs, scroll text, pages of text, building name signs, etc.

Ambient audio event expert 604 composites with media an audio track where a brand is mentioned as a part of the ambient audio track. Ambient audio event expert 604 analyzes and identifies background audio content of the media where an inserted audio event would be complementary to the currently existing audio content. Ambient audio event expert 604 analyzes signals of the media's audio track(s) to determine if there is an opportunity to mix an audio-only offer or product placement into the existing audio track. If a logical insertion point for ambient audio is found, ambient audio event expert 604 outputs code to describe the point within each space of media that is suitable for the ambient audio to be inserted and generates a list of all the space for which this event is valid. The ambient audio expert also takes into account the overall acoustic properties of the target audio track to seamlessly mix the new audio into the target track and can take into account metadata from the visual track as well to support compositing of audio over relevant visual content such as visual and auditory depictions of an event in which ambient audio is expected or of people listening to an audio signal.

For example, an ambient audio event may be identified in a baseball game scene where the ambient audio inserted could be “Get your ice cold Budweiser here.”

Music placement event expert 605 composites an audio track with the media wherein a portion of the music composition is laid into the ambient soundtrack. Thus, it is similar to ambient audio event expert 604 but instead of composting a piece of ambient audio (which is typically non-musical and of a short duration in time), music placement event expert 605 composites a track of music. Music placement event expert 605 outputs code to describe the space of media that is suitable for the music track to be inserted and generates a list of all the space for which this event is valid.

For example, as depicted in FIG. 7, music placement event expert 605 may analyze a series of video frames (e.g. 48 frames, 2 seconds, etc.) 56, 57, 58, 59, 501 during which a music track may be composited with the other sounds within the media. As depicted in FIG. 7, a suitable place is found at 63.

Referring again to FIG. 4, CDM 44 (both that which was explicitly annotated by users or producers, and that which is derived by expert processes) is anchored to discrete points or ranges in time and/or graphical coordinates. Because the vast majority of objects (video frames, seconds of audio, ranges of pixels, etc.) remain un-annotated, probability expert 51, depicted in FIG. 4, computes probability distributions for the validity of these attributes in the spaces surrounding the points where annotations have been made. For example, suppose for a particular piece of media, certain segments are tagged with “sunny” at 1 minute 14 seconds, 1 minute 28 seconds, 1 minute 32 seconds, and 1 minute 48 seconds. Probability expert 51 computes a likelihood that the label “sunny” would also apply to times within, and surrounding the tag anchors that were not explicitly tagged (e.g., if a user thought it was sunny at 1 minute 14 seconds, the odds are good that they would also have agreed that the tag would be appropriate at 1 minute 15 seconds, 1 minute 16 seconds, etc.). The probability distributions applied by probability expert 51 are specific to the type of metadata being extrapolated, subject to the existence and density of other reinforcing or refuting metadata. For example, an absence of other tags over the next 30 seconds of media, coupled with signal analysis that the same region was relatively uniform in audiovisual content, followed by a sudden change in the rate of frame-to-frame change in the video coupled with the presence of other tags that do not mean “sunny” would let probability expert 51 derive that the length of this exemplary media region was approximately 30 seconds.

As depicted in FIG. 3, offers are entered into the system by issuing an insertion order 39 to offer server 37, either directly, or through an advertiser web service 41. Insertion order 39 is a request from the advertiser that a particular offer be composited with a content file or stream. When insertion order 39 is placed, offer server 37 collects information associated with the insertion order 39, including but not limited to, the offer, the overall campaign, and the brand represented by the offer that is stored in offer asset store 84. Offer asset store 84 may be implemented as one or more databases implemented on one or more pieces of computer readable memory. The information stored in or associated with offer asset store may include: creative specifications, including but not limited to, format, tactic, layout, dimensions, and length; description of content, including but not limited to, subject, objects, actions, and emotions; location of creative, including but not limited to, video, audio, and text assets that are assembled to create the offer; resultant, including but not limited to, desired shifts in brand attitudes arising from exposure to the creative; targeting rules, including but not limited to, demographic selects, geographies, date/time restrictions, and psychographics; black/white lists; frequency and impression goals; and financial terms associated with the offer and campaign, including but not limited to, the maximum price per impression or per type of user or users or per specific user or users the advertiser is willing to spend and budget requirements such as caps on daily, weekly, or monthly total spend.

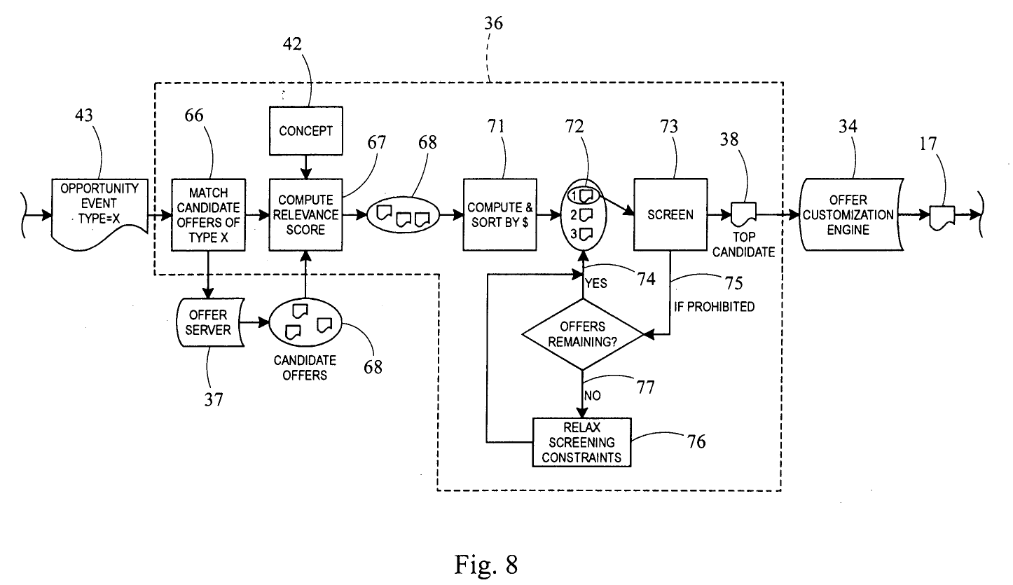

FIG. 8 details an embodiment of offer optimization engine 36 which may be implemented as a single piece or multiple pieces of software code running on the same or different processors and stored in computer readable memory. For each opportunity event 43 received, the offer optimization engine 36 selects a best offer 17 to associate with that opportunity event 43. Density thresholds may be set to limit the maximum number of offers and offer types permitted. Density thresholds may also include frequency and timing constraints that determine when and how often the offers and offer types may be deployed. In these cases the optimization engine 36 attempts to maximize revenue against the density thresholds and constraints.

Opportunity event expert 43 searches offer server 37 for all offers of the type matching 66 opportunity event 43 (e.g. “type: Billboard”) to produce an initial candidate set of offers 68. For each candidate offer in the set of candidate offers 68, a relevance score 37 is computed that represents the distance between the offer's resultant, e.g. desired impact of exposure to the offer and the concepts 42 identified by semantic expert engine 35 that are in closest proximity to opportunity event 43. The offer's relevance score is then multiplied by the offer's maximum price per impression or per type of user or users or per specific user or users 71. The candidate set of offers 68 is then sorted 71 by this new metric, the top candidate 72 is selected.

Candidate offer 72 is then screened 73 against any prohibitions set by media rights holder and any prohibitions set by offer advertiser, e.g., not allowing a cigarette advertisement to be composited with a children's cartoon. If a prohibition exists 75 and there are offers remaining 74, the next highest-ranked candidate 72 is selected, and the screen is repeated 73.

However, if, no offers remain 77, the screening constraints are relaxed 76 to broaden the possibility of matches in this offer context, and the process starts over. Constraint relaxation may be based on specified parameters (e.g., a willingness to accept less money for an offer, changing the target demographics, changing the time, or allowing a poorer content match). However, there is a goal that the constraints not be relaxed too much so as to damage the media content, e.g., placing a soda can on the head of a character in the scene (unless that is what the advertiser desires).

The top candidate offer 38 is then passed to the offer customization engine 34 that will customize and composite offer 38 with the media and form final offer asset 17.

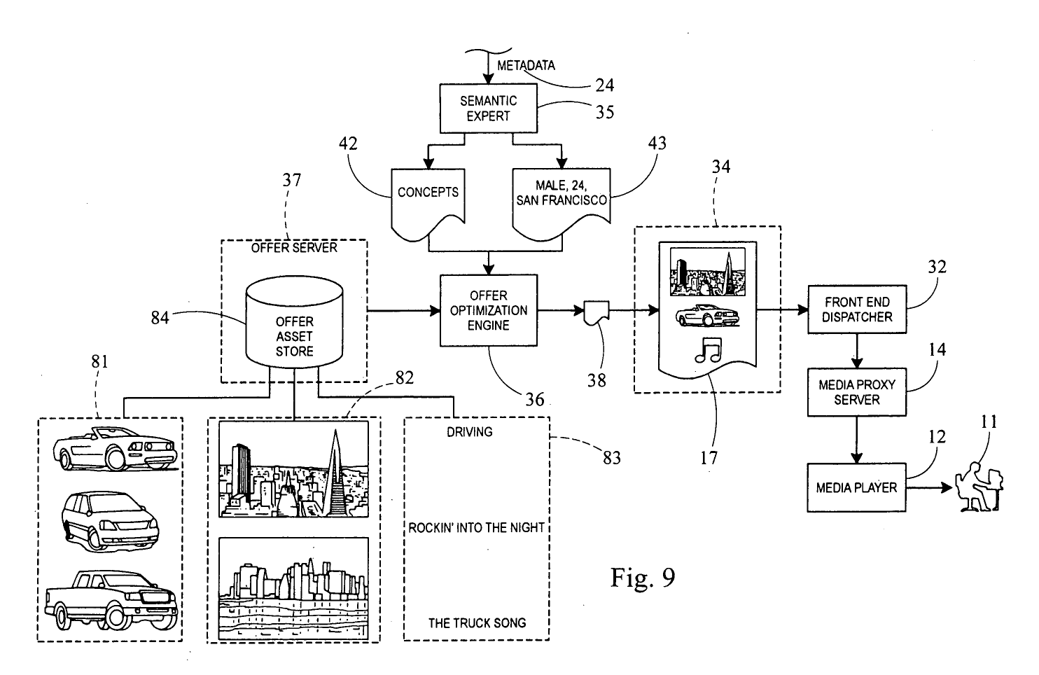

FIG. 9 illustrates an exemplary interstitial advertisement for advertising of a vehicle within a content file or stream. The advertisement is customized for a specific end user 11 based on what is known about end user 11. Thus, rather than deliver a single, generic advertisement to all viewers, the brand is able to market a specific product to a particular type of user; for example, a vehicle seller may wish to market a family vehicle, a utility vehicle, or a sports/lifestyle vehicle depending upon the user viewing the advertisement.

Metadata 24 concerning content file or stream 18 (FIG. 2) is fed into semantic expert 35 (FIG. 4). Semantic expert 35 parses the data and retrieves concepts 42 and details regarding the user 43. That information is then fed into offer optimization engine 36 (FIG. 8) that is able to select the best offer by using information regarding the offer received from the offer server 37. Offer asset store 84 of offer server includes information regarding the offer and may be implemented as one or more databases implemented on one or more pieces of computer readable memory. Offer asset store 84 and offer server 37 need not be located at the same or contiguous address locations.

In this example, the information stored in offer asset store 84 includes data concerning vehicle 81 to be portrayed in a 20-second video clip in which the vehicle is shot against a compositing (e.g., a blue screen or green screen) background. This segmented content allows easy compositing of the foreground content against a variety of backgrounds. Instead of a fixed background, the brand may wish to customize the environment 82 that the vehicle appears in depending upon the user's geographical location. New York users may see the vehicle in a New York skyline background. San Francisco users may see a Bay Area skyline. Background music 83 may also be selected to best appeal to the individual user 11 (perhaps as a function of that users' individual music preferences as recorded by the user's MP3 player or music downloading service).

Based on information regarding the user 43 and concepts 42, a particular offer can be constructed that is tailored for that user. For example, offer optimization engine 36 may select an offer comprising a sports car driving in front of the Golden Gate Bridge playing the music “Driving” for a user 11 who is a young male located in San Francisco. Offer optimization engine 36 then passes best offer 38 to offer customization engine 34 which then constructs the pieces of the best offer 38 into a final offer 17.

Final offer 17 is then delivered back to user 11. Depending upon hardware and bandwidth limitations, final composite offer 17 may be handed off to a real-time or streaming media server or assembled on the client site by media player 12. An alternative implementation could include passing media player 12 pointers to the storage locations 81, 82, 83 for those composites, rather than passing back assembled final offer 17.

The foregoing description and drawings are provided for illustrative purposes only and are not intended to limit the scope of the invention described herein or with regard to the details of its construction and manner of operation. It will be evident to one skilled in the art that modifications and variations may be made without departing from the spirit and scope of the invention. Additionally, it is not required that any of the component software parts be resident on the same computer machine. Changes in form and in the proportion of parts, as well as the substitution of equivalents, are contemplated as circumstances may suggest and render expedience; although specific terms have been employed, they are intended in a generic and descriptive sense only and not for the purpose of limiting the scope of the invention set forth in the following claims.

What is claimed is:

1. A method for providing a best offer with a sequential content file, the method comprising:
receiving an offer request to provide a best offer with a sequential content file wherein the sequential content file has associated metadata;
retrieving a plurality of offers from an offer store;
determining at least one opportunity event in the sequential content file;
optimizing the plurality of offers to determine the best offer;
customizing the best offer with the sequential content file; and
providing the best offer with the sequential content file.

2. The method of claim 1, wherein the offer request further comprises a user id.

3. The method of claim 1, wherein the determining at least one opportunity event in the sequential content file further comprises separating a content descriptor metadata of the sequential content file from other metadata of the sequential content file.

4. The method of claim 1, wherein the determining at least one opportunity event in the sequential content file further comprises analyzing the metadata using a canonical expert.

5. The method of claim 1, wherein the determining at least one opportunity event in the sequential content file further comprises analyzing the metadata using a disambiguation expert.

6. The method of claim 1, wherein the determining at least one opportunity event in the sequential content file further comprises analyzing the metadata using a concept expert.

7. The method of claim 1, wherein the determining at least one opportunity event in the sequential content file further comprises analyzing the metadata using an opportunity event expert to determine whether a marketing opportunity exists within the sequential content file.

8. The method of claim 7, wherein the opportunity event expert further comprises at least an interstitial advertisement event expert, a visual product placement event expert, an endorsement event expert, a visual sign insert event expert, an ambient audio event expert, a music placement event expert, or a textual insert event expert.

9. The method of claim 1, wherein the determining at least one opportunity event in the sequential content file further comprises analyzing the metadata using a probability expert.

10. (canceled)

11. (canceled)

12. The method of claim 1, wherein the optimizing the plurality of offers to determine the best offer further comprises:
computing a relevance score for each of the plurality of offers; and
selecting as the best offer the offer with a highest relevance score.

13. (canceled)

14. The method of claim 12, wherein the method further comprises screening the offer with the highest relevance score.

15. The method of claim 14, wherein the method further comprises selecting an offer with the next highest relevance score as the best offer if the offer with the highest relevance score fails the screen.

16. The method of claim 15, wherein the screening the offer with the highest relevance score further comprises using one or more constraints and relaxing the one or more constraints if an offer with the next highest relevance score does not exist.

17. The method of claim 1, wherein the customizing the best offer with the sequential content file further comprises varying an element of the best offer or sequential content file using a datum about an end user.

18. In a computer readable storage medium having stored therein data representing instructions executable by a programmed processor to provide a best offer with a sequential content file, the storage medium comprising instructions for:
receiving an offer request to provide a best offer with a sequential content file;
retrieving a plurality of offers from an offer store;
determining at least one opportunity event in the sequential content file;
optimizing the plurality of offers to determine the best offer; and
providing the best offer with the sequential content file.

19. (canceled)

20. A computer system comprising:
a semantic expert engine to analyze metadata of a sequential content file;
an offer optimization engine to select a best offer from a plurality of offers; and
an offer customization engine to customize the best offer and the sequential content file.

21. The system of claim 20, wherein the semantic expert engine further comprises a canonical expert to canonicalize annotations of the metadata.

22. The system of claim 20, wherein the semantic expert engine further comprises a concept expert for determining one or more concepts of the sequential content file.

23. The system of claim 20, wherein the semantic expert engine further comprises an opportunity event expert to identify offer opportunities of the sequential content file.

24. The system of claim 23, wherein the opportunity event expert further comprises at least an interstitial advertisement event expert, a visual product placement event expert, an endorsement event expert, a visual sign insert event expert, an ambient audio event expert, a music placement event expert, or a textual insert event expert.

25. (canceled)

26. (canceled)

27. A computer system comprising:
one or more computer programs configured to determine a best offer for association with a sequential content file from a plurality of offers by analyzing one or more pieces of metadata associated with the sequential content file.

28. The system of claim 27, wherein the system further comprises one or more computer programs that analyze an annotation of the metadata to identify one or more concepts of the sequential content file.

29. The system of claim 27, wherein the system further comprises one or more computer programs that varies an element of the best offer or sequential content file using data about an end user.

30. The system of claim 27, wherein the one or more computer programs;
compute a relevance score for each of the offers of the plurality of offers;
select the offer with the highest relevance score as the best offer;
screen the best offer against a prohibition set; wherein if the screen of the offer yields no remaining offers, a constraint of the screen is relaxed.

31. (canceled)

32. The system of claim 27, wherein the best offer is provided with the sequential content file as an interstitial advertisement event, a visual product placement event, an endorsement event, a visual sign insert event, an ambient audio event, a music placement event, or a textual insert event.
